(19) United States
(12) Patent Application Publication
(10) Pub. No.: US 2005/0011543 A1
(43) Pub. Date: Jan. 20, 2005

(54) Process for recovering a dry cleaning solvent from a mixture by modifying the mixture

(76) Inventors: John Christian Haught, West Chester, OH (US); Arseni Valerevich Radomyselski, Loveland, OH (US); Robb Richard Gardner, Cincinnati, OH (US); Jeffrey Scott Dupont, Cincinnati, OH (US); Victor Manuel Arredondo, West Chester, OH (US); Mark Robert Sivik, Mason, OH (US); Jeffrey John Hopkins, West Chester, OH (US); William Michael Scheper, Guilford, IN (US)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/876,131

(22) Filed: Jun. 24, 2004

Related U.S. Application Data
(60) Provisional application No. 60/547,126, filed on Feb. 24, 2004.
(60) Provisional application No. 60/483,290, filed on Jun. 27, 2003.

(51) Int. Cl. B08B 3/14

(52) U.S. Cl. 134/42

(57) ABSTRACT

A method of recover dry cleaning solvents from a mixture containing a used dry cleaning solvent and contaminants, such as laundry soils, fabric treating agents. Specifically, purification agents are added to the mixture to effect a change in the mixture such that the contaminants become less soluble in the mixture and can be easily separated from the dry cleaning solvents.

### CROSS REFERENCE TO RELATED APPLICATIONS

This application claims the benefit of U.S. Provisional Application Ser. No. 60/547,126 filed on Feb. 24, 2004; and U.S. Provisional Application Ser. No. 60/483,290 filed on Jun. 27, 2003.

### FIELD OF THE INVENTION

The present invention relates to a process for recovering dry cleaning solvents from a mixture containing a used dry cleaning solvent and contaminants, such as laundry soils, fabric treating agents. Specifically, purification agents are added to the mixture to effect a change in the mixture such that the contaminants become less soluble in the mixture and can be easily separated from the dry cleaning solvent.

### BACKGROUND OF THE INVENTION

Conventional laundering techniques for cleaning and refreshing (e.g., removing malodors) fabric articles can be generally categorized into the aqueous-based washing technique and the “dry cleaning” technique. The former involves immersion of the fabric article in a solution comprising primarily of water; detergent or soap may be added to enhance the cleaning function. The latter typically involves the use of non-aqueous fluids as the agent for cleaning and refreshing.

Water and dry cleaning solvents, after being used in a laundering treatment, typically comprise contaminants, such as dyes, water and/or surfactants. Since the dry cleaning solvents are more expensive than water, there is a need to recycle/reuse the dry cleaning solvents in more than one treatment. Conventional dry cleaning solvents are subjected to a distillation method to remove some contaminants. However, equipment and conditions to run a distillation method are extremely burdensome, energy consuming, and not practical for use in a consumer's home. Accordingly, there is a need to remove contaminants from dry cleaning solvents without distillation. Representative systems using the distillation method are disclosed in EP 543,665 and U.S. Pat. Nos. 5,942,007; 6,056,789; 6,059,845; and 6,086,635.

One attempt at such non-distillative method is evident by the use of a commercially available KleenRite® filter. The KleenRite® filter is made of a clay absorbent and an activated carbon adsorbent. Representative filters containing carbon and clay adsorbent materials are disclosed in U.S. Pat. Nos. 4,277,336 and 3,658,459. However, such filter has a rather limited lifetime due to the high percentage of clay absorbent in the filter. The clay absorbent has a finite capacity for absorbing contaminants, such as water, and once that capacity is met, the filter must be replaced with a new filter. In addition to the limitations around the clay absorbent, the activated carbon adsorbent has limitations also. The particle size and/or pore size of the activated carbon adsorbent material allows many contaminants to flow past the activated carbon adsorbent material, thus making the filter ineffective. Further, in conventional use, the used, contaminated dry cleaning solvent is pumped through the filter at a rate that does not allow the clay absorbent and/or activated carbon adsorbent to remove contaminants effectively.

Therefore, there is a need for a method that effectively removes contaminants from a dry cleaning solvent such that the purified solvent can be recycled/reused.

It is also desirable to have a method capable of purifying a dry cleaning solvent in an economical and energy efficient manner. Additionally, it is desirable that the purification method is safe. Therefore, there is a need for a non-distillation method that removes contaminants from the dry cleaning solvent at low temperature and ambient pressure.

It is further desirable to have a method that changes the characteristics of the mixture thereby rendering the contaminants less soluble in the mixture such that the contaminants can be easily separated from the mixture.

### SUMMARY OF THE INVENTION

The present invention relates to a process for purifying a dry cleaning solvent containing contaminants, the process comprising the steps of:
a. obtaining a mixture comprising a lipophilic fluid and at least one contaminant;
b. contacting the mixture with a purification agent, thereby changing the solubility of the contaminant in the mixture; and
c. separating the contaminant from the lipophilic fluid.

The present invention also relates to a process for purifying a used, contaminated lipophilic fluid, the process comprising the steps of:
a. contacting a fabric article containing laundry soils with a lipophilic fluid and a composition comprising a fabric treating agent, thereby producing a mixture comprising the lipophilic fluid, laundry soils and the fabric treating agent;
b. extracting at least a portion of the mixture from the fabric article;
c. contacting the mixture with a purification agent, thereby changing the solubility of the contaminant in the mixture; and
d. separating the fabric treating agent and/or laundry soils from the lipophilic fluid.

In one aspect of the present invention, the purification agent changes the ionic strength change or pH change in the mixture, thereby reduces the solubility of the contaminants in the mixture.

In another aspect of the present invention, the purification agent is a flocculating agent that causes agglomeration of the contaminants in the mixture, thereby reduces the solubility of the contaminants in the mixture.

In yet another aspect of the invention, the purification agent is a gelling agent that causes a viscosity change in the mixture, thereby reduces the solubility of the contaminants in the mixture.

In still another aspect of the present invention, the purification agent is an incompatible liquid, which is added to the mixture, thereby the contaminants are preferentially extracted from the mixture into the incompatible liquid.

### DETAILED DESCRIPTION

Definitions

The term “fabric article” as used herein means any article that is customarily cleaned in a conventional laundry process or in a cleaning process. As such, the term encompasses articles of clothing, linen, drapery, and clothing accessories. The term also encompasses other items made in whole or in part of fabric, such as tote bags, furniture covers, tarpaulins and the like.

The term “absorbent material” or “absorbent polymer” as used herein means any material capable of selectively ingesting (i.e., absorbing or adsorbing) water and/or water-containing liquids without ingesting dry cleaning solvents. In other words, absorbent materials or absorbent polymers comprise a water absorbing agent, which is referred to in the art as “gel”, “polymeric gel” and “super absorbent polymers”.

The terms “fabric treatment composition” or “fabric treating composition” as used herein mean a dry cleaning solvent-containing composition that comes into direct contact with fabric articles to be cleaned. It is understood that the composition may also provide uses other than cleaning, such as conditioning, sizing, and other fabric care treatments. Thus, it may be used interchangeably with the term “fabric care composition”. Furthermore, optional cleaning adjuncts (such as additional detersive surfactants, bleaches, perfumes, and the like) and other fabric care agents may be added to the composition. It is understood that the term “fabric treating agent/additive” or “fabric care agent/additive” encompasses the cleaning adjuncts and the finishing or fabric care additives.

The term “dry cleaning” or “non-aqueous cleaning” as used herein means a non-aqueous fluid is used as the dry cleaning solvent to clean a fabric article. However, water can be added to the “dry cleaning” method as an adjunct cleaning agent. The amount of water can comprise up to about 25% by weight of the dry cleaning solvent or the cleaning composition in a “dry cleaning” process. The non-aqueous fluid is referred to as the “lipophilic fluid” or “dry cleaning solvent”.

The terms “soil” or “laundry soil” as used herein means any undesirable extraneous substance on a fabric article that is the target for removal by a cleaning process. By the terms “water-based” or “hydrophilic” soils, it is meant that the soil comprised water at the time it first came in contact with the fabric article, or the soil retains a certain amount of water on the fabric article. Examples of water-based soils include, but are not limited to beverages, many food soils, water soluble dyes, bodily fluids such as sweat, urine or blood, outdoor soils such as grass stains and mud. On the other hand, the term “lipophilic” soils, as used herein means the soil has high solubility in or affinity for the lipophilic fluid. Examples of lipophilic soils include, but are not limited to body soils, such as mono-, di-, and tri-glycerides, saturated and unsaturated fatty acids, non-polar hydrocarbons, waxes and wax esters, lipids; and laundry materials such as nonionic surfactants; and mixtures thereof.

As used herein, the term “insoluble” means that a material will physically separate (i.e. settle-out, flocculate, float) from the liquid medium (a dry cleaning solvent or water) within 24 hours after being added to the liquid medium, whereas the term “soluble” means that a material does not physically separate from the liquid medium within 24 hours after addition.

Lipophilic Fluid

“Lipophilic fluid” as used herein means any liquid or mixture of liquid that is immiscible with water at up to 20% by weight of water. In general, a suitable lipophilic fluid can be fully liquid at ambient temperature and pressure, can be an easily melted solid, e.g., one that becomes liquid at temperatures in the range from about 0° C. to about 60° C., or can comprise a mixture of liquid and vapor phases at ambient temperatures and pressures, e.g., at 25° C. and 1 atm. pressure.

The suitable lipophilic fluid may be non-flammable or, have relatively high flash points and/or low VOC characteristics, these terms having conventional meanings as used in the dry cleaning industry, to equal to or exceed the characteristics of known conventional dry cleaning fluids.

Non-limiting examples of suitable lipophilic fluid materials include siloxanes, other silicones, hydrocarbons, glycol ethers, glycerine derivatives such as glycerine ethers, perfluorinated amines, perfluorinated and hydrofluoroether solvents, low-volatility nonfluorinated organic solvents, diol solvents, other environmentally-friendly solvents and mixtures thereof.

“Siloxane” as used herein means silicone fluids that are non-polar and insoluble in water or lower alcohols. Linear siloxanes (see for example U.S. Pat. Nos. 5,443,747, and 5,977,040) and cyclic siloxanes are useful herein, including the cyclic siloxanes selected from the group consisting of octamethyl-cyclotetrasiloxane (tetramer), dodecamethyl-cyclohexasiloxane (hexamer), decamethyl-cyclopentasiloxane (pentamer, commonly referred to as “D5”), and mixtures thereof. A suitable siloxane may comprise more than about 50% cyclic siloxane pentamer, or more than about 75% cyclic siloxane pentamer, or at least about 90% of the cyclic siloxane pentamer. Also suitable for use herein are siloxanes that are a mixture of cyclic siloxanes having at least about 90% (or at least about 95%) pentamer and less than about 10% (or less than about 5%) tetramer and/or hexamer.

The lipophilic fluid can include any fraction of dry-cleaning solvents, especially newer types including fluorinated solvents, or perfluorinated amines. Some perfluorinated amines such as perfluorotributylamines, while unsuitable for use as lipophilic fluid, may be present as one of many possible adjuncts present in the lipophilic fluid-containing composition.

Other suitable lipophilic fluids include, but are not limited to, diol solvent systems e.g., higher diols such as C₆ or C₈ or higher diols, organosilicone solvents including both cyclic and acyclic types, and the like, and mixtures thereof.

Non-limiting examples of low volatility non-fluorinated organic solvents include for example OLEAN® and other polyol esters, or certain relatively nonvolatile biodegradable mid-chain branched petroleum fractions.

Non-limiting examples of glycol ethers include propylene glycol methyl ether, propylene glycol n-propyl ether, propylene glycol t-butyl ether, propylene glycol n-butyl ether, dipropylene glycol methyl ether, dipropylene glycol n-propyl ether, dipropylene glycol t-butyl ether, dipropylene glycol n-butyl ether, tripropylene glycol methyl ether, tripropylene glycol n-propyl ether, tripropylene glycol t-butyl ether, tripropylene glycol n-butyl ether.

Non-limiting examples of other silicone solvents, in addition to the siloxanes, are well known in the literature, see, for example, Kirk Othmer's Encyclopedia of Chemical Technology, and are available from a number of commercial sources, including GE Silicones, Toshiba Silicone, Bayer, and Dow Corning. For example, one suitable silicone solvent is SF-1528 available from GE Silicones.

Non-limiting examples of suitable glycerine derivative solvents include materials having the following structure: 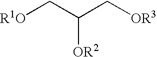
wherein R¹, R² and R³ are each independently selected from: H; branched or linear, substituted or unsubstituted C₁-C₃₀ alkyl, C₂-C₃₀ alkenyl, C₁-C₃₀ alkoxycarbonyl, C₃-C₃₀ alkyleneoxyalkyl, C₁-C₃₀ acyloxy, C₇-C₃₀ alkylenearyl; C₄-C₃₀ cycloalkyl; C₆-C₃₀ aryl; and mixtures thereof. Two or more of R¹, R² and R³ together can form a C₃-C₈ aromatic or non-aromatic, heterocyclic or non-heterocyclic ring.

Non-limiting examples of suitable glycerine derivative solvents include 2,3-bis(1,1-dimethylethoxy)-1-propanol; 2,3-dimethoxy-1-propanol; 3-methoxy-2-cyclopentoxy-1-propanol; 3-methoxy-1-cyclopentoxy-2-propanol; carbonic acid (2-hydroxy-1-methoxymethyl)ethyl ester methyl ester; glycerol carbonate and mixtures thereof.

Non-limiting examples of other environmentally-friendly solvents include lipophilic fluids that have an ozone formation potential of from about 0 to about 0.31, lipophilic fluids that have a vapor pressure of from about 0 to about 0.1 mm Hg, and/or lipophilic fluids that have a vapor pressure of greater than 0.1 mm Hg, but have an ozone formation potential of from about 0 to about 0.31. Non-limiting examples of such lipophilic fluids that have not previously been described above include carbonate solvents (i.e., methyl carbonates, ethyl carbonates, ethylene carbonates, propylene carbonates, glycerine carbonates) and/or succinate solvents (i.e., dimethyl succinates).

“Ozone Reactivity” as used herein is a measure of a VOC's ability to form ozone in the atmosphere. It is measured as grams of ozone formed per gram of volatile organics. A methodology to determine ozone reactivity is discussed further in W. P. L. Carter, “Development of Ozone Reactivity Scales of Volatile Organic Compounds”, Journal of the Air & Waste Management Association, Vol. 44, Page 881-899, 1994. “Vapor Pressure” as used can be measured by techniques defined in Method 310 of the California Air Resources Board.

In one embodiment, the lipophilic fluid comprises more than 50% by weight of the lipophilic fluid of cyclopentasiloxanes, (“D5”) and/or linear analogs having approximately similar volatility, and optionally complemented by other silicone solvents.

The level of lipophilic fluid, when present in the treating compositions according to the present invention, is from greater than about 50% to about 99.99%, or from about 60% to about 95%, or from about 70% to about 90% by weight of the treating composition.

Fabric Care Composition

The fabric treatment composition for use in treating/cleaning fabric articles may comprise a lipophilic fluid, a fabric treating agent having one or more functional moieties, and optionally, water, polar solvents, cleaning adjuncts and/or fabric treating agents.

A given fabric treating agent, when present in the composition, typically comprises from about 0.01% to about 80%, or from about 0.5% to about 60%, or from about 1% to about 50% by weight of the composition. The fabric treating agents are not required to be present at the same concentration. For example, an enzyme can be present at a level of about 1/10 to about 1/100 of the level of a detersive surfactant.

When the composition is diluted with the lipophilic fluid to form the wash liquor, a given fabric treating agent, when present, typically comprises from about 0.0001% to about 50%, or from about 0.01% to about 30%, or from about 1% to about 20% by weight of the wash liquor.

In some embodiments, polar solvents may optionally be incorporated into the wash liquor as well. The polar solvent may be added as a component of the fabric treatment composition or as a co-solvent of the lipophilic fluid in the wash liquor. The polar solvent can be water, and optionally also includes linear or branched C1-C6 alcohols, C1-C4 glycols and mixtures thereof.

When present, the polar solvent ranging from about 99% to about 1%, or from about 5% to about 40%, by weight of the composition; and cleaning adjuncts ranging from about 0.01% to about 50%, or from about 5% to about 30%, by weight of the composition.

Contaminants

The contaminants that may enter the dry cleaning solvent during fabric article treating processes typically include laundry soils, especially lipophilic laundry soils, such as nonionic surfactants, saturated and unsaturated fatty acids, mono-, di- and tri-glycerides, non-polar hydrocarbons, waxes and wax esters, lipids, and mixtures thereof.

The contaminants may also come from the fabric treating agents in the composition, including, but are not limited to: soil release polymers, detersive surfactants, bleaches, enzymes, perfumes, softening agents, finishing polymers, dyes, dye transfer inhibiting agents, dye fixatives, fiber rebuild agents, wrinkle reducing and/or removing agents, fiber repair agents, perfume release and/or delivery agents, shape retention agents, fabric and/or soil targeting agents, antibacterial agents, anti-discoloring agents, hydrophobic finishing agents, UV blockers, brighteners, pigments (e.g., Al₂O₃, TiO₂), pill prevention agents, temperature control agent, skin care lotions (comprising humectants, moisturizers, viscosity modifiers, fragrances, etc.), insect repellents, fire retardants, and mixtures thereof.

Method

During the fabric article treating process, the dry cleaning solvent and/or composition typically become contaminated with contaminants, such as those disclosed above. The present invention is directed to a method for removing contaminants from a used, contaminated dry cleaning solvent, which is a mixture of the lipophilic solvent and the contaminants. Specifically, the method involves changing the mixture in such a manner that the contaminants are rendered less soluble in the mixture to facilitate the separation of the contaminants and the solvent.

Modification of the mixture can be effected by contacting the mixture with a purification agent, such as an ionic strength modifier, a pH modifier, a flocculating agent, a gelling agent, a biological agent, a liquid extraction agent, and mixtures thereof. As the mixture gets modified by the purification agents of the present invention, the contaminants become less soluble in the modified mixture and the contaminants may begin to separate out of the bulk solvent, as indicated by cloudiness, precipitate forming, and the like.

As used herein, the term “less soluble” or “less compatible” means the difference in Hansen solubility parameters of the dry cleaning solvent and the contaminant becomes larger upon modification of the contaminant. It is known that Hansen solubility parameter is based on the sum of the effects of hydrogen bonding, polarity and dispersion, which are determined by the molecular structure.

The solvent purification method of the present invention provides several advantages over conventional distillative solvent recovery method. First, the modification to the solvent/contaminants mixture can be conducted in non-thermal (i.e., does not involve distillation), low temperature and ambient pressure conditions. Second, by rendering the contaminants into less soluble, they may precipitate out of the solvent and thus, can be easily removed be known techniques, such as decantation, filtration, centrifugation, and the like.

The dry cleaning solvent thus purified can be used as working solvent in subsequent fabric article cleaning cycles. It is recognized that the present method can also be applied to purify or recycle dry cleaning composition, which may comprise an emulsion of a dry cleaning solvent and water, optionally, various contaminants, such as cleaning adjuncts and laundry soils.

A purification device suitable for use herein will remove sufficient contaminants from the dry cleaning solvent or composition such that the level of contaminants in the purified solvent or composition does not impair its performance when it is used as the working solvent or reformulated (by replacing the cleaning adjuncts that may have been removed in the process) as the working composition in subsequent fabric article treating processes. The removal of contaminants in the purification process can be 100% removal of contaminants, but it does not have to be. Removal of about 50% to about 100% of contaminants present in the used, contaminated solvent or composition can be sufficient. The type of fabric articles, type of contaminant, level of soiling, etc. are factors influencing the level of contaminants that may remain in the purified solvent or composition without impairing its cleaning performance. That is, the purified solvent or composition may comprise a higher level of one type of contaminant than another. For example, the level of dyes may be present from about 0.0001% to about 0.1%, or from about 0.00001% to about 0.1%, or from about 0% to about 0.01% by weight of the working solvent. On the other hand, the level of water in the purified solvent may be from about 0.001% to about 20%, or from about 0.0001% to about 5%, or from about 0% to about 1%.

In one aspect of the invention, the purified dry cleaning solvent or composition can be collected and/or reformulated and can be re-used immediately in several additional fabric cleaning cycles before they need to be purified with the method of the present invention. In another aspect of the invention, the purified dry cleaning solvent or composition can be removed from the cleaning system, stored and used later as the working solvent or composition in another system or another fabric cleaning cycle.

Further, the method of the present invention may be applied to the solvent or composition via an integral (e.g., in-line) component of the cleaning system or as an accessory (e.g., post cleaning cycle) component of the cleaning system.

The method comprises a first step of providing a mixture of a dry cleaning solvent and at least one contaminant. The mixture may be generated by exposing a fabric article to a dry cleaning solvent or a cleaning composition comprising dry cleaning solvent and other cleaning adjuncts such as water or surfactants. Alternatively, water may be applied from a separate source to the fabric article in this cleaning step. Then, the used and/or contaminated dry cleaning solvent or cleaning composition, typically in the form of the dry cleaning solvent and water emulsion, can be collected and used as the mixture needing purification in the present method.

The cleaning methods to provide the contaminated solvent or composition include conventional immersive cleaning methods as well as the non-immersive cleaning methods disclosed in U.S. Patent Publications US20020133886A1 and US20020133885A1.

Purification Agents

In one aspect of the invention, the purification agents can be ionic strength modifiers, such as the mono-valent alkaline metal cations, or the di-valent alkaline earth metal cations or the di- or multi-valent transitional metal cations. Nonlimiting examples include cations of Na; K; Li; Cs; Zn; Mg; Mn; Ni; Ba; Fe; La; Ce; Zr; Ca; Ce; Al; Cu; Fe; in their cationically charged form, in their magnetizable form; and mixtures thereof.

The purification agents can also comprise unsubstittued or substituted ammonium cations, such as NH₄⁺ and quaternary ammonium cations. Quaternary ammonium surfactants are described in the art. The properties of these surfactants are very strongly influenced by the type of substituent they contain. Chain length, degree of saturation, branching or the presence and number of hydroxylic or ethoxy groups are some of the factors determining the properties of the surfactant. Whereas typical textile-conditioning actions are performed by cationic surfactants with two long alkyl chains, cationic surfactants with only one long alkyl chain have been reported to improve the detergency performance in laundry detergents. Nonlimiting examples of quaternary ammonium compounds suitable for use herein as the purification agents are disclosed in U.S. Pat. No. 3,123,640 and U.S. Pat. No. 3,141,905, both of which describe cation-active surface-active chemical compounds. The cation-active compounds are quaternary ammonium compounds derived from lower monoalkyl dialkanolamines. The cation-active compounds also include a) dialiphatic, dialkoxylated quaternary ammonium compounds, and b) monoaliphatic, trialkoxylated quaternary ammonium compounds. Additional exmples include but are not limited to decyltrimethyl ammonium compounds, octyldihydroxyethylmethyl ammonium compounds, and the like.

These cations may be applied to the contaminated solvents or mixtures in their salt form, which contain anionic species of hadiles (F⁻, Cl⁻, Br⁻, I⁻), hydroxide (OH⁻), carboxylates (CO₃⁻), sulfates (SO₄⁻), sulfites (SO₃⁻), nitrates (NO₃⁻), nitrites (NO₂⁻), phosphates (PO₄⁻), and mixtures thereof.

The purification agents based on metal cations, NH₄⁺; quaternary ammonium cations, and mixtures thereof, are typically prepared as a solution in a carrier solvent at a concentration of about 0.1 to about 1 wt % of the carrier solvent. The carrier solvent is a solvent capable of allowing for the cation to dissociate from its salt form. Nonlimiting examples of carrier solvent include water or pH adjusted water. These cationic agents typically interact with the anionic species in the contaminants; the resulting compounds can be easily precipitated out of and separated from the dry cleaning solvent by convention techniques, such as filtration, centrifugation, decantation, and combinations thereof.

By exposing the collected precipitants to a low pH (about 2-4) medium, the precipitants can be dissolved into the cationic agents and the anionic contaminants. The cationic agents can be reclaimed by passing the solution containing the dissolved precipitants through a cation exchange column.

Alternatively, a magnetic field can be applied to draw the precipitants out of the dry cleaning solvent, since some of the metal cations may be in a magnetizable form. Once the precipitants have been removed from the dry cleaning solvent, the magnetic field can be reversed, to release the precipitants into a low pH medium, and the cationic agents can be regenerated and recycled as described above.

The ability to recycled or regenerated the cationic agents provide a great advantage since no additional materials needing disposal is generated by the solvent purification method of the present invention.

In another aspect of the present invention, the purification agents may be pH modifiers selected from mineral acids or organic acids. Mineral acids include, bur are not limited to, HCl, HBr, HI, sulfuric acid, sulfonic acid, nitric acid, phosphoric acid, carboxylic acid. These pH modifiers may have one, two or three dissociable protons. Organic acids refer to the above mineral acids having replaced one or more of the protons with linear, branched or cyclic, saturated or unsaturated alkyl groups.

In still another aspect of the invention, the purification agent may be an aggregation agent such as, water or polymers. For example, water is well-known to induce formation of surfactant aggregates in non-polar solvents that may contain two or more surfactant molecules per aggregate. Thus, the aggregates may become large enough to be separated from the mixture more easily by the separation techniques disclosed herein. The aggregation agents include, but are not limited to, cationic or anionic polymers such as diallyl dimethyl, flocculants such as poly(ethylene oxide), poly(methacrylate) and poly(acrylic acid).

Addition of aggregation agent may be combined with a treatment such as agitation (mixing) and/or sonication to disperse aggregation agent and to provide mechanical energy to induce contaminant molecules to condense into aggregates.

In yet another aspect of the present invention, the purification agent may be a gelling agent such as sorbitol derivatives, metal fatty ester soaps, calcium silicates and treated calcium silicates, organic derivatives of castor oil, cellulose derivatives, lecithin, xanthum gum, alginate, and mixtures thereof.

A class of sorbitol derivatives can be used as gelling agents in the present invention. For example, 1,2:2,4-di-O-benzylidene-D-sorbitol (DBS) can form aggregated structures, via hydrogen bonding, in a wide variety of organic solvents, including the lipophilic solvents used herein. Adding the sorbitol gelators to the mixture can result in the formation of aggregates between the sorbitol gelators and contaminants capable of forming hydrogen bonding. The resulting aggregates can be separated from the lipophilic fluids easily.

Metal ester soaps can be used as the gelling agents to further facilitate the separation of the contaminants from the lipophilic fluid. Metal ester soaps comprise a metal ion, such as aluminum, magnesium, zinc, and lithium, and an ester having the general formula: R(CO)O⁻, wherein the R can be saturated or unsaturated, linear, branched or cyclic C1-C30 alkyl chains. For example, suitable metal fatty esters may comprise metal ions selected from aluminum, magnesium, zinc or lithium, and the fatty acid ester having a chain length of 10 to 28 carbon atoms, or 12 to 22 carbon atoms, such as stearates, behenates, laurates and palmitates. The aluminum/magnesium hydroxide stearate is commercially available from Giulini Corporation, Bound Brook, N.J., under the general name of Gilugel®.

It is understood that the cations in the metal ester soap can also function as the ionic strength modifiers.

Calcium silicates and treated calcium silicates can also be used as the gelling agent in the present invention. Common forms of calcium silicates include CaSiO₃, CaSiO₄(OH)₂, CaSiO₅(OH)₄. The calcium silicates can be treated with a wide variety of nonpolar organic compounds to render the materials more hydrophobic and less reactive. Useful calcium silicates that are commercially available include the following: Hubersorb® (Huber Corp., Harve de Grace, Md.), and Micro-Cel®I (Celite Corp., Denver, Colo.). Other silicates such as magnesium silicate, or magnesium/aluminum silicate are also useful herein.

Also suitable for use herein as the gelling agent are various organic derivatives of castor oil, such as Thixcin® R, Thixatrol® ST, and the like. The principal constituent of these castor oil derivative is glyceryl tris-12-hydroxystearate. Various inorganic derivatives of castor oil are also useful herein, such as Thixcin® GR, Thixatrol® GST, Thixseal® 1084, and the like. All these castor oil derivatives or mixtures thereof are available from Rheox, Inc., Hightstown, N.J.

Exemplary cellulose derivatives useful as gelling agents in the present invention include cellulose acetate, cetyl hydroxy ethyl cellulose and other modified celluloses.

Other suitable gelling agents may be derived from natural sources, such as xanthum gum, lecithin, alginate, and the like.

A liquid immiscible with the lipophilic fluid can be used as the liquid extraction agent. A liquid extraction agent, such as an immiscible liquid, can be added to the mixture to provide a second phase, and the contaminant(s) can preferentially migrate from the lipophilic fluid or the mixture to the the second phase or the immiscible liquid. The driving force is based on the partition coefficient of the contaminant(s) in the respective liquids.

Extracting fluids capable of creating a second phase from the lipophilic fluid are suitable for use herein. Nonlimiting examples of liquid extracting agents include, but are not limited to, of water; linear or branched, cyclic, acyclic or aromatic alcohols; linear or branched, cyclic, acyclic or aromatic diols; and mixtures thereof.

Separation Techniques

After the mixtures of contaminants and lipophilic fluid have been treated with the purification agent such as those described above, the contaminants can be separated from the lipophilic fluid or the mixture using several well known techniques, such as precipitation; sedimentation; centrifugation; decantation; particulate filtration; membrane filtration; exposure to an absorbent, an adsorbent, a photocatalyst, or mixtures thereof; magnetic separation; temperature modification; liquid-liquid extraction; and combinations thereof.

The contaminants that become insoluble in the mixture can be separated from the dry cleaning solvent or mixture by density- and/or gravity-based techniques, such as precipitation, sedimentation, decantation, centrifugation.

Precipitation is initiated by a phase separation, which leads to the formation of a solid. Subsequently, gravity separates the solid from the bulk solvent in a 1 to 48 hour time period. Additionally, the formation of a precipitate causes an optical change in the bulk solvent, such that the bulk solvent becomes hazy or cloudy.

Sedimentation is the separation of suspended solid particles from a liquid stream via gravitational settling. Sedimentation can also be used to separate solid particles based on differences in their settling rates.

“Decantation” and “density gradation” are gravity-type separation methods. A “decanter” is defined as a vessel used to separate a stream continuously into two liquid phases using the force of gravity. Using Stokes' law, one can derive the settling velocity of the droplets in the continuous phase and design a decanter accordingly.

Centrifugation is a technique that separates materials based upon differences in density, the rate of separation being amplified by applying increasing rotational force. The force is called a centrifugal force and the apparatus providing the rotational force is called a centrifuge. Centrifugation can be used in combination with precipitation or sedimentation to enhance and accelerate the separation.

When the purification agents contain cationic agents based on the alkaline earth metal cations or transitional metal cations, or in their magnetizable form, magnetization can be used to remove the modified contaminants (i.e., precipitants) from the solvent.

Additionally, temperature modification, such as lowering the temperature of the mixture, can further enhance the separation of the contaminants from the mixture. For example, the compatibility or solubility of the contaminants in the solvent or mixture can be reduced with lowering temperature. In another example, the contaminants may undergo phase change (such as crystallization) and precipitate out of the solvent or mixture.

Particulate filtration can be used for the removal of solid particulates, aggregates, or precipitants from liquids. For example, liquids with low solids content can be filtered such that they become optically clear liquids. The cartridges are typically cylindrical in configuration, though other shapes are also acceptable. The filterer media inside the cartridge can be either pleated or non-pleated, disposable or cleanable/regenerable. The filter media is usually supported by and/or integrally bonded to plastic or metal hardware.

Membrane filtration encompasses the transfer of solute through a membrane or the transfer of solvent through a membrane, as a driving force across the membrane. Dialysis and osmosis are embodiments of membrane filtration techniques. In contrast to particulate filtration, membrane filtration is effective in the removal of low molecular weight solute molecules or ions from a solution by passing them through a membrane driven by a concentration gradient, and optionally, a pressure gradient, across the membrane.

Membranes suitable for use herein may comprise porous inorganic materials, such as alumina, zirconia, titania, silicium carbide, and mixtures thereof. Membranes suitable for use herein may also comprise organic materials such as polytetrafluoroethylene; poly(vinylidene fluoride); polypropylene; polyethylene; cellulose esters; polycarbonate; polysulfone/poly(ether sulfone); polyimide/poly(ether imide); aliphatic polyamide; polyetheretherketone; cross linked polyalkylsiloxane; and mixtures thereof. Suitable membranes are commercially available from GEA Filtration, or GE Osmonics Inc., Minnetoka, Minn.

In one embodiment where low molecular weight solutes are retained on or in the membrane, rather than passing through the membrane; the solutes can be washed out with solvents or water by exchanging salts and other microspecies with the solute molecules. Thus, membrane can be regenerated. Repeated or continuous addition of fresh solvent flushes out the low molecular weight solutes efficiently and rapidly.

The modified contaminants can also be removed from the dry cleaning solvent or composition by contacting the mixture with an absorbent material, an adsorbent material, a photocatalyst, or mixtures thereof. These materials can be added to the mixture as solid particulates/powders or can be contained in a cartridge or like container.

Suitable adsorbent materials include, but are not limited to, activated carbon, clay, polar agents, apolar agents, charged agents, zeolites, nanoparticles, and mixtures thereof.

The polar agent suitable for use herein as the adsorbent material has the formula:
(Yₐ—O_{b})X
wherein Y is Si, Al, Ti, P; a is an integer from about 1 to about 5; b is an integer from about 1 to about 10; and X is a metal. In one embodiment, the polar agent suitable for use herein as the adsorbent material is selected from the group consisting of: silica, diatomaceous earth, aluminosilicates, polyamide resin, alumina, zeolites and mixtures thereof. In one embodiment, the polar agent is silica, more specifically silica gel. Suitable polar agents include Silfam® silica gel, available from Nippon Chemical Industries Co., Tokyo, Japan; and Davisil® 646 silica gel, available from W. R. Grace, Columbia, Md.

Apolar agents suitable for use herein as the adsorbent material comprise one or more of the following: polystyrene, polyethylene, and/or divinyl benzene. The apolar agent may be in the form of a fibrous structure, such as a woven or nonwoven web. Suitable apolar agents include Amberlite® XAD-16 and XAD4, available from Rohm & Haas, Philadelphia, Pa.

The charged agents suitable for use herein are selected from the group consisting of: anionic materials, cationic materials, zwitterionic materials and mixtures thereof. In one embodiment, the charged agent has the formula:
(W-Z)T
wherein W is Si, Al, Ti, P, or a polymer backbone; Z is a charged substituent group and T is a counterion selected from alkaline, alkaline earth metals and mixtures thereof. For example, T may be: sodium, potassium, ammonium, alkylammonium derivatives, hydrogen ion; chloride, hydroxide, fluoride, iodide, carboxylate, etc. The W portion typically comprises from about 1% to about 15% by weight of the charged agent. The polymer backbone typically comprises a material selected from the group consisting of: polystryrene, polyethylene, polydivinyl benzene, polyacrylic acid, polyacrylamide, polysaccharide, polyvinyl alcohol, copolymers of these and mixtures thereof. The charged substituent typically comprises sulfonates, phosphates, quaternary ammonium salts and mixtures thereof. The charged substituent may comprise alcohols; diols; salts of carboxylates; salts of primary and secondary amines and mixtures thereof. Suitable charged agents are available from Rohm & Haas, Philadelphi, Pa., under the designation IRC-50.

Suitable absorbent materials include, but are not limited to, hydrogel-forming absorbent materials or absorbent gelling material (AGM), and mixtures thereof.

Hydrogel-forming absorbent polymers are also commonly referred to as “hydrocolloids” and can include polysaccharides, such as carboxymethyl starch, carboxymethyl cellulose, and hydroxypropyl cellulose; nonionic types such as polyvinyl alcohol, and polyvinyl ethers; cationic types such as polyvinyl pyridine, polyvinyl morpholinione, and N,N-dimethylaminoethyl or N,N-diethylaminopropyl acrylates and methacrylates, and the respective quaternary salts thereof. The copolymers thereof may be partially neutralized, slightly network crosslinked, or both. Typically, hydrogel-forming absorbent polymers have a multiplicity of anionic or cationic functional groups. These polymers can be used either alone or in a mixture of two or more different polymers. Examples of these polymer materials are disclosed in U.S. Pat. Nos. 3,661,875; 4,076,663; 4,093,776; 4,666,983, and 4,734,478.

Other hydrogel forming materials are also suitable for use herein as the absorbent materials. Nonlimiting examples of these gels suitable for use herein may be based on acrylamides, acrylates, acrylonitriles, diallylammonium chloride, dialkylammonium chloride, and other monomers. Some suitable gels are disclosed in U.S. Pat. Nos. 4,555,344, 4,828,710, and European Application EP 648,521 A2.

The hydrogel-forming polymer component may also be in the form of a mixed-bed ion-exchange composition comprising a cation-exchange hydrogel-forming absorbent polymer and an anion-exchange hydrogel-forming absorbent polymer. Such mixed-bed ion-exchange compositions are described in, e.g., U.S. patent application Ser. No. 09/130,321, filed Jan. 7, 1998 by Ashraf, et al. (P&G Case 6976R); and U.S. Pat. No. 6,121,509.

The Cleaning System and Apparatus

The present invention also includes a cleaning system and apparatus suitable for use in the method described above. The cleaning system comprises a fabric article treating vessel, a dry cleaning solvent reservoir, and optionally, a sensor for monitoring the contaminant level in the dry cleaning solvent. When contaminants concentration exceeds some pre-determined value, it would indicate that the dry cleaning solvent has reached maximum contaminant holding tolerance and needs to be purified. Additionally, solvent purification/recovery device comprising a modification treatment unit capable of conducting the purification method of the present invention may also be provided as an integral part of the system/apparatus. However, it needs not be. The solvent purification/recovery unit can be a stand-alone device, separate from the dry cleaning system.

Any suitable fabric article treating vessel known to those of ordinary skill in the art can be used. The fabric article treating vessel receives and retains a fabric article to be treated during the operation of the cleaning system. In other words, the fabric article treating vessel retains the fabric article while the fabric article is being contacted by the dry cleaning solvent. Nonlimiting examples of suitable fabric article treating vessels include commercial cleaning machines, domestic, in-home, washing machines, and clothes drying machines.

The methods and systems of the present invention may be used in a service, such as a cleaning service, diaper service, uniform cleaning service, or commercial business, such as a Laundromat, dry cleaner, linen service which is part of a hotel, restaurant, convention center, airport, cruise ship, port facility, casino, or may be used in the home.

The methods of the present invention may be performed in an apparatus that is a modified existing apparatus and is retrofitted in such a manner as to conduct the method of the present invention in addition to related methods.

The methods of the present invention may also be performed in an apparatus that is specifically built for conducting the present invention and related methods.

Further, the methods of the present invention may be added to another apparatus as part of a dry cleaning solvent processing system. This would include all the associated plumbing, such as connection to a chemical and water supply, and sewerage for waste wash fluids.

The methods of the present invention may also be performed in an apparatus capable of “dual mode” functions. A “dual mode” apparatus is one capable of both washing and drying fabrics within the same vessel (i.e., drum). Dual mode apparatuses for aqueous laundry processes are commercially available, particularly in Europe. Additionally, the method of the present invention may also be performed in an apparatus capable of performing “bi-modal” cleaning functions. A “bi-modal” apparatus is one capable of performing both non-aqueous washing and aqueous washing in the same vessel, wherein the two washing modes can be performed in sequential washing cycles or in a combination washing cycle. Additionally, the bi-modal machine is capable of fully drying the clothes without having to transfer them to a separate machine. That is, a machine can have the bi-modal function as well as the dual-mode function.

An apparatus suitable for use in the present invention will typically contain some type of control systems, including electrical systems, such as “smart control systems”, as well as more traditional electromechanical systems. The control systems would enable the user to select the size of the fabric load to be cleaned, the type of soiling, the extent of the soiling, the time for the cleaning cycle. Alternatively, the control systems provide for pre-set cleaning and/or refreshing cycles, or for controlling the length of the cycle, based on any number of ascertainable parameters the user programmed into the apparatus. For example, when the collection rate of dry cleaning solvent reaches a steady rate, the apparatus could turn its self off after a fixed period of time, or initiate another cycle for the dry cleaning solvent.

In the case of electrical control systems, one option is to make the control device a so-called “smart device”, which provides smart functions, such as self diagnostics; load type and cycle selection; Internet links, which allow the user to start the apparatus remotely, inform the user when the apparatus has cleaned a fabric article, or allow the supplier to remotely diagnose problems if the apparatus malfunctioned. Furthermore, the apparatus of the present invention can also be a part of a cleaning system, the so called “smart system”, in which the present apparatus has the capability to communicate with another laundry apparatus that performs a complimentary operation (such as a washing machine or a dryer) to complete the remainder of the cleaning process.

Test Method

Thin Layer Chromatography

The percentage of contaminants removed from the lipophilic fluid can determined by Thin Layer Chromatography (TLC).

A vial containing a mixture of 100 grams of a lipophilic liquid and 0.1 grams of an artificial body soil (available from Empirical Manufacturing Company Inc., Cincinnati, Ohio) and 0.1 grams of Neodol 91-2.5 surfactant (available from Shell Chemical Co., Houston, Tex.) is prepared; both the artificial body soil and the surfactant are considered contaminants for the purpose of this test.

Two microliters samples are taken from the above mixture before and after it is purified by the present method. Both samples are analyzed by TLC on Silica Gel G plates (inorganic binder, #01011, 20 cm×20 cm, available from Analtech, Inc. Newark, Del.).

Three developing solvents were used in the TLC analysis: (1) 100% heptane; (2) toluene:hexane at a volume ratio of 160:40; and (3) hexane:diethyl ether:acetic acid at a volume ratio of 160:40:2; all solvents were purchased from Burdick & Jackson. The first solvent system is allowed to migrate up to the top of the TLC plate to the horizontal line (17.5 cm) and typically takes about 30 minutes. The TLC plate is dried for 20 minutes. The second solvent system is allowed to migrate 16.5 cm up the plate and typically takes about 26 minutes. The TLC plate is dried for 30 minutes. The third solvent system is allowed to migrate 9.5 cm up the plate and typically takes about 9 minutes. The TLC plate is dried for 30 minutes. Spray the dried TLC plate evenly with 5-7 milliliters of 25% sulfuric acid and place on a hot plate heated to 250°-260° C and covered with a ceramic tape. Allow the plate to remain on the hot plate until fully charred (10-30 minutes). The charring time will vary according to the compounds tested. Remove the plate from the hot plate with heated spatulas (to prevent breakage) and place on a glass cloth pad to cool. The charred plated is scanned using Camag Scanner 3 densitometer (from Camag, Switzerland).

A TLC spectrum was measured as area under the curve displayed by the densitometer. The total contaminants removed from the mixture was calculated using formula:

$$MR = S - ( \frac{A}{B} * S )$$

wherein
MR=Mass of contaminants removed;
S=Mass of contaminants added to the mixture;
A=TLC area from the mixture purified by the present method; and
B=TLC area from the mixture before the purification process.

### EXAMPLES

### Example

### Base Extraction

A mixture to simulate the dirty, used dry cleaning solvent generated by one or more laundry cycles is prepared by mixing D5 and laundry soils (such as triglyceride, oleic acid) together to form a substantially homogeneous solution. Water and alkaline earth metal salt (sodium hydroxide) are premixed, then added to the mixture containing D5 and laundry soils to make a purifying mixture according to the following proportions. The purifying mixture is mixed together for one hour with an air mixer at 30 psi pressure, followed by recovery of the purified D5. The residual soil content in the purified D5 can be determined by TLC.

| Component | Concentration (Wt. %) |
|---|---|
| Decamethylcyclopentasiloxane (D5) | 98.0% |
| Triglyceride | 1.0% |
| Oleic Acid | 1.0% |
| Water | 0.8% |
| Sodium Hydroxide | 0.08% |

While particular embodiments of the present invention have been illustrated and described, it would be apparent to those skilled in the art that various other changes and modifications can be made without departing from the spirit and scope of the invention. It is therefore intended to cover in the appended claims all such changes and modifications that are within the scope of this invention.

All percentages stated herein are by weight unless otherwise specified. It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited are, in relevant part, incorporated herein by reference; the citation of any document is not to be construed as an admission that it is prior art with respect to the present invention.

1. A process for purifying a lipophilic fluid containing contaminants, the process comprising the steps of:
a. obtaining a mixture comprising a lipophilic fluid and at least one contaminant;
b. contacting the mixture with a purification agent, thereby changing the solubility of the contaminant in the mixture; and
c. separating the contaminant from the lipophilic fluid.

2. The process according to claim 1 wherein the purification agent is selected from the group consisting of an ionic strength modifier, a pH modifier, a flocculating agent, a gelling agent, a liquid extraction agent, and mixtures thereof.

3. The process according to claim 1 wherein the purification agent is a cation of alkaline, alkaline earth or transitional metals selected from the group consisting of Na; K; Li; Cs; Zn; Mg; Mn; Ni; Ba; Fe; La; Ce; Zr; Ca; Ce; Al; Cu; Fe; magnetizable forms thereof, salt forms thereof, and mixtures thereof.

4. The process according to claim 1 wherein purification agent is a cation selected from the group consisting of NH₄⁺, alkyl substituted NH₄⁺, quaternary ammonium cations, salts thereof, and mixtures thereof.

5. The process according to claim 1 wherein the purification agent is a pH modifier selected from the group consisting of mineral acids, organic acids and mixtures thereof.

6. The process of claim 5 wherein the pH modifier is selected from the group consisting of HCl, HBr, HI, sulfuric acid, sulfonic acid, nitric acid, phosphoric acid, carboxylic acid, and mixtures thereof.

7. The process according to claim 1 wherein the purification agent is an aggregation agent which is a polymer selected from the group consisting of diallyl dimethyl, poly(ethylene oxide), poly(methacrylate), poly(acrylic acid), and mixtures thereof.

8. The process according to claim 1 wherein the purification agent is a gelling agent selected from the group consisting of sorbitol gelators, metal fatty ester soaps, calcium silicates and treated calcium silicates, organic derivatives of castor oil, cellulose derivatives, lecithin, xanthum gum, alginate, and mixtures thereof.

9. The process according to claim 1 wherein the purification agent is an extracting fluid that is immiscible with the lipophilic fluid.

10. The process according to claim 9 wherein the extracting fluid is selected from the group consisting of water; linear or branched, cyclic, acyclic or aromatic alcohols; linear or branched, cyclic, acyclic or aromatic diols; and mixtures thereof.

11. The process according to claim 3 wherein step (c) comprises subjecting the mixture to a magnetic field, thereby precipitating the contaminant out of the liphophilic fluid.

12. The process according to claim 1 wherein step (c) is selected from the group consisting of precipitation; sedimentation; centrifugation; decantation; particulate filtration; membrane filtration; exposure to an absorbent, an adsorbent, a photocatalyst, or mixtures thereof; magnetic separation; temperature modification; liquid-liquid extraction; and combinations thereof.

13. The process according to claim 1 wherein step (c) comprises passing the lipophilic fluid through a membrane, thereby the lipophilic fluid becomes substantially free of contaminant.

14. The process according to claim 13 wherein the membrane comprises a porous inorganic material selected from the group consisting of alumina, zirconia, titania, silicium carbide, and mixtures thereof.

15. The process according to claim 13 wherein the membrane comprises a polymeric material selected from the group consisting of polytetrafluoroethylene; poly(vinylidene fluoride); polypropylene; polyethylene; cellulose esters; polycarbonate; polysulfone/poly(ether sulfone); polyimide/poly(ether imide); aliphatic polyamide; polyetheretherketone; cross linked polyalkylsiloxane; and mixtures thereof.

16. The process according to claim 1 wherein the contaminant is a lipophilic soil selected from the group consisting of mono-, di-, and tri-glycerides, saturated and unsaturated fatty acids, non-polar hydrocarbons, waxes and wax esters, lipids; non-ionic surfactants; and mixtures thereof.

17. The process according to claim 16 wherein the contaminant further comprises a fabric treating agent selected from the group consisting of soil release polymers, additional detersive surfactants, bleaches, enzymes, perfumes, softening agents, finishing polymers, dyes, dye transfer inhibiting agents, dye fixatives, fiber rebuild agents, wrinkle reducing and/or removing agents, fiber repair agents, perfume release and/or delivery agents, shape retention agents, fabric and/or soil targeting agents, antibacterial agents, anti-discoloring agents, hydrophobic finishing agents, UV blockers, brighteners, pigments, pill prevention agents, temperature control agents, skin care lotions, insect repellents, fire retardants, and mixtures thereof.

18. The process according to claim 1 wherein the lipophilic fluid is selected from the group consisting of siloxanes, hydrocarbons, fluorocarbons, glycol ethers, glycerine ethers, and mixtures thereof.

19. A process according to claim 1 wherein the lipophilic fluid comprises decamethylcyclopentasiloxane.

20. A process for purifying a used contaminated lipophilic fluid, the process comprising the steps of:
c. contacting a fabric article containing laundry soils with a lipophilic fluid and a composition comprising a fabric treating agent, thereby producing a mixture comprising the lipophilic fluid, laundry soils and the fabric treating agent;
d. extracting at least a portion of the mixture from the fabric article;
c. contacting the mixture with a purification agent, thereby changing the solubility of the contaminant in the mixture; and
d. separating the fabric treating agent and/or laundry soils from the lipophilic fluid.
